(19) United States
(12) Patent Application Publication
(10) Pub. No.: US 2004/0213919 A1
(43) Pub. Date: Oct. 28, 2004

(54) Coating process and coated base material

(76) Inventor: Reinhard Fried, Nussbaumen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/202,170

(22) Filed: Jul. 25, 2002

(30) Foreign Application Priority Data
Aug. 3, 2001 (CH) 2001 1430/01

(51) Int. Cl. B05D 1/08

(52) U.S. Cl. 427/455

(57) ABSTRACT

The invention discloses a process for coating a base material (1) which is subject to friction with a protective layer (2) comprising MCrAlY by means of a thermal spraying process. The MCrAlY is fed to an injection nozzle in powder form and is applied to the base material (1). At the same time as the MCrAlY powder, a ceramic material in powder form, such as for example Al₂O₃, Si₃N₄, SiC, AlN, Cr₃C₂, MoSi₂ or an equivalent material, is applied to the base material (1), a diffusion heat treatment is carried out and those locations of the applied coating (3) which are subject to friction are cut into a toothed or pointed shape.

### FIELD OF THE INVENTION

The invention relates to a process for coating a base material with a protective layer comprising MCrAlY by means of a thermal spraying process in accordance with the preamble of claim 1 and to a base material in accordance with the preamble of claim 8.

### BACKGROUND OF THE INVENTION

It is generally known, from numerous publications, to provide turbine blades or vanes, i.e. guide vanes or rotor blades of gas turbines, with one or more protective layers in order to protect the turbine blade or vane from the thermal and mechanical loads, oxidation and other harmful influences which arise during operation and to extend the service life of the turbine blade or vane in this way. A first protective layer of the turbine blade or vane generally consists of a metallic alloy, such as MCrAlY, where M represents Ni, Co or Fe. This type of metallic coating is used to protect against oxidation. Then, different process parameters are used to apply a rougher layer of MCrAlY. This layer is also known as a bond coating. Metallic coatings and coating processes of this type are known from numerous documents belonging to the prior art, for example from U.S. Pat. No. 3,528,861, U.S. Pat. No. 4,585,481, U.S. Pat. No. 4,152,223, U.S. Pat. No. 3,754,903, U.S. Pat. No. 3,676,085, U.S. Pat. No. 4,346,137, U.S. Pat No. 4,419,416, U.S. Pat. No. 4,743,514, U.S. Pat. No. 4,313,760 or U.S. Pat. No. 4,973,445.

Moreover, a second protective layer comprising TBC (thermal barrier coating), which consists of a ceramic material (Y-stabilized Zr oxide) and serves as thermal protection, is applied. U.S. Pat. No. 4,055,705, U.S. Pat. No. 4,248,940, U.S. Pat. No. 4,321,311 or U.S. Pat. No. 4,676,994 disclose ceramic protective layers of this type. Subsequent heat treatments (diffusion heat treatment, DHT) then ensure improved bonding between the coating and the base material.

The coatings are applied using conventional coating processes, for example thermal spraying processes, such as plasma spraying processes (air plasma spraying, APS, low pressure plasma spraying, LPPS, or vacuum plasma spraying VPS, high power plasma spraying HPPS), high-velocity spraying (high velocity oxy-fuel, HVOF), flame spraying, detonation spraying processes, wire spraying or high-pressure air spraying. U.S. Pat. No. 6,083,330, the article Development in thermal spray coatings, Engine yearbook 2001, pp. 92-99, EP-A3 911,422, U.S. Pat. No. 5,652,028, EP-A1 482,831 or U.S. Pat. No. 5,741,556 disclose processes of this type for applying the abovementioned coatings. In addition, electrical or chemical deposition processes (physical or chemical vapor deposition PVD, CVD) are known, for example, from U.S. Pat. No. 4,152,223 or U.S. Pat. No. 4,275,090.

The use of these coatings in reinforcements or stripping coatings, as occur, for example, in sealing tips of labyrinth seals or at the tips of turbine blades or vanes, is of particular importance, since at these locations these parts are subject to stripping phenomena during operation. The reinforcement works itself way into a run-coating on an opposite, second component. In the case of a gas turbine blade or vane, this second component is a heat-accumulation segment. Run-in coatings of this type are abradable and generally comprise a corrosion-resistant and erosion-resistant layer. A stripping coating at the tip of a gas turbine blade or vane is required in particular if the strength and hardness of the run-in coatings are high, so that the wear to the gas-turbine blade or vane is additionally increased in this way. During operation, the stripping operation which occurs between the stripping coating and the run-in coating leads to the formation of a minimal gap. However, the efficiency of a compressor or turbine is greatly dependent on the gap size between the rotating component and the stationary component The efficiency is disadvantageously reduced by the increasing wear to the blade or vane tips.

### SUMMARY OF THE INVENTION

It is an object of the invention to provide a process for producing a stripping coating which, in terms of manufacturing technology, can be carried out in the simplest possible way and which results in a high-quality reinforcement. Moreover, it is intended in particular to achieve a superior cutting capacity or cutting ability of this stripping coating. The invention also relates to a base material which has been coated using the process according to the invention and has a stripping coating.

According to the invention, in a process in accordance with the preamble of claim 1, this object is achieved by the fact that at the same time as the MCrAlY powder a ceramic material in powder form is fed to the injection nozzle, and the two materials are applied to the base material together, and before or after the diffusion heat treatment those locations of the applied protective layer which are subject to friction are cut into a toothed or pointed shape.

The invention also relates to a base material which is subject to friction, has been coated using the process as claimed in one of claims 1 to 7, contains ceramic particles and in particular hard-material phases and is cut into a toothed or pointed shape at locations which are subject to friction.

The ceramic powder used may be one or a combination of the following materials: Al₂O₃, Si₃N₄, SiC, AlN, Cr₃C₂ and MoSi₂ or equivalent materials, it being possible for the two powders to be fed to the injection nozzle individually or together. If SiC is used, hard phases consisting of silicides, carbides, etc. advantageously form after the heat treatment. The ceramic powder may be added to the MCrAlY powder in a mixing ratio of between 5:95 and 65:35 (ceramic: MCrAlY).

The ceramic particles increase the cutting capacity of the coating. The toothed or pointed shape can be cut, for example, to a height of 0.1 to 1 mm, depending on the particular application. The special shape of the locations which are subject to friction means that there are always sufficient ceramic edges available, so that a sufficient cutting capacity and space for a sufficient chip volume becomes possible. In addition, the protective layer applied may be segmented, in order to reduce stresses.

The base material will advantageously be the tip of a gas turbine blade or vane or another part of a gas turbine or a compressor which is subject to friction.

The thermal spraying process used may be a plasma spraying process, high-velocity spraying, flame spraying, a detonation spraying process, wire spraying or high-pressure air spraying.

### BRIEF DESCRIPTION OF THE DRAWINGS

The invention is explained in more detail with reference to the appended drawings, in which

FIG. 1 shows a turbine blade or vane with a coating according to the invention at the tip, and

FIG. 2 shows a sectional image with a SiC ceramic incorporated in the MCrAlY after the heat treatment has taken place,

FIG. 3 shows a sectional image with Al₂O₃ ceramic incorporated in the MCrAlY after the heat treatment has taken place, and

FIG. 4 shows a sectional image through the tip of the turbine blade or vane which has been processed using a laser modeling process.

Only the elements which are pertinent to the invention are illustrated.

### DETAILED DESCRIPTION OF THE INVENTION

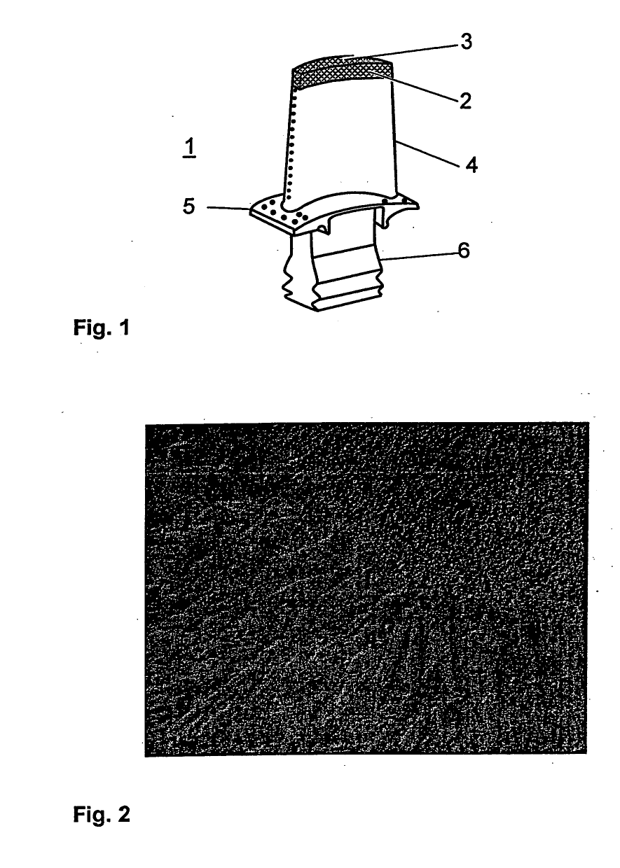

The invention relates to a process for coating a base material 1 which is subject to friction with a protective layer 3 comprising MCrAlY as illustrated by way of example in FIG. 1. This process is carried out using thermal spraying processes which are known in the prior art, such as plasma spraying processes, high-velocity spraying, flame spraying, detonation spraying processes, wire spraying or high-pressure air spraying. In these processes, the coating materials are melted in a high-energy heat source, for example in a carrier gas, and are applied to the base material 1 in droplet form using suitable means.

In the advantageous exemplary embodiment illustrated in FIG. 1, the base material 1 which is subject to friction is a turbine blade or vane 1, i.e. a guide vane or rotor blade of a gas turbine or a compressor, having a tip 2, a platform 3 and a blade root 4. The tip 2, which is subject to friction while the turbine blade or vane 1 is operating, has been coated using the process according to the invention. Of course, it may also be another part of a gas turbine or a compressor which is subject to friction.

The turbine blade or vane 1 consists, for example, of a superalloy. A nickel-based superalloy of this type is known, for example, from U.S. Pat. No. 5,759,301. A turbine blade or vane consisting of a cobalt-based superalloy or of steel is also conceivable. The turbine blade or vane 1 is coated with a metallic alloy comprising MCrAlY using the process described above, the MCrAlY being fed to an injection nozzle in powder form, where it is melted and then applied to the turbine blade or vane 1.

According to the invention, at the same time as the MCrAlY powder, a ceramic material in powder form is applied to the turbine blade or vane 1. The ceramic powder used may be one or a combination of the following materials Al₂O₃, Si₃N₄, SiC, AlN, Cr₃C₂ or MoSi₂. Furthermore, oxidation-resistant ceramics which are stable at temperatures of up to or even above 1200° C. can be used.

Then, a diffusion heat treatment will be carried out. A heat treatment of this type is known from the prior art and is carried out, for example, at 1150° C. for 1 to 10 hours. It is used to improve the bonding of the applied protective layer to the base material. The result is material-to-material bonding between the MCrAlY matrix and the base material.

FIG. 2 shows a microsection of an incorporated ceramic comprising SiC which after the diffusion heat treatment has reacted with the MCrAlY, so that silicides and carbides have formed. The ceramic particles in this case form an acicular hard-material phase with the MCrAlY as matrix.

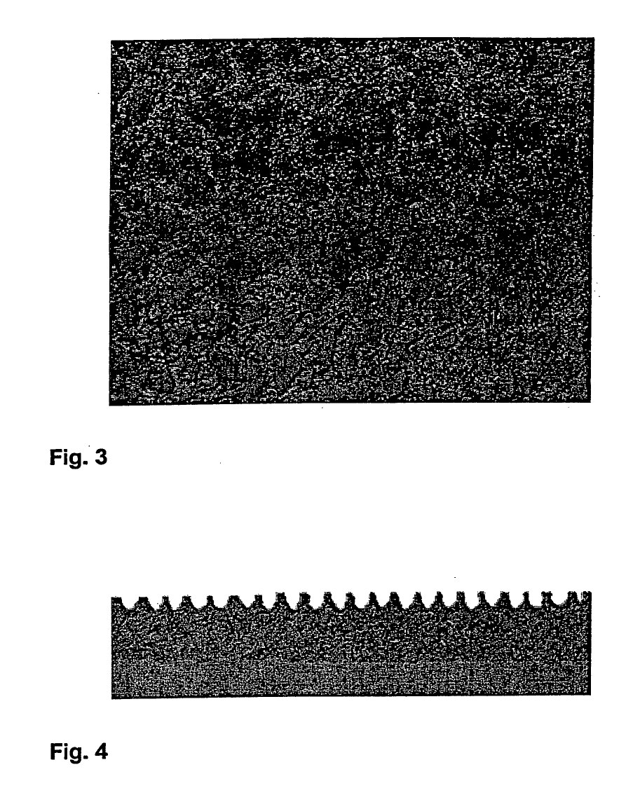

FIG. 3 shows a microsection of an incorporated ceramic Al₂O₃. After the diffusion heat treatment, the sprayed MCrAlY matrix has undergone intensive diffusion bonding to the base material.

As can be seen from FIG. 4, those locations of the applied coating 3 which are subject to friction are cut into a toothed or pointed shape or into another equivalent shape. A laser or other suitable cutting tools can be used for this purpose. The particular shape of the locations which are subject to friction means that there are always sufficient ceramic cutting edges available, so that a sufficient cutting capacity and space for a sufficient chip volume are possible. In principle, the shape cutting may also take place before the heat treatment. Depending on the particular application, the toothed or pointed shape may, for example, be cut to a height of 0.1 to 1 mm. In addition, the applied protective layer may be segmented, i.e. interrupted or divided in some other way, in order to reduce stresses.

The two powders can be fed to the injection nozzle individually or together during the coating process, it being possible for the ceramic powder to be added to the MCrAlY powder in a mixing ratio of between 5:95 and 65:35 (ceramic: MCrAlY). The MCrAlY serves as matrix in the form of a holding function for the ceramic, and the added hard material improves the cutting capacity. The more ceramic particles are added, the greater the cutting capacity of the applied protective layer 3.

### LIST OF REFERENCE SYMBOLS

1 Base material, turbine blade or vane

2 Tip of the turbine blade or vane 1

3 Protective coating

4 Blade part

5 Platform

6 Blade root

1. (Canceled)

2. A process for coating a base material, which is subject to friction, with a stripping coating working into an abradable run-coating on an opposite, second component during operation and comprising MCrAlY by means of a thermal spraying process, the MCrAlY being fed in powder form to an injection nozzle and being applied to the base material which is subject to friction, and then a diffusion heat treatment being carried out, wherein,
a ceramic material in powder form is fed to the injection nozzle, and the MCrAlY powder and the ceramic material are applied to the base material together; and
before or after the diffusion heat treatment, locations of the applied stripping coating which are subject to friction are cut into a toothed or pointed shape,
wherein M is selected from the group consisting of Ni, Co, and Fe, and
wherein the ceramic powder used is one or a combination of the following materials: Al₂O₃, Si₃N₄, SiC, AlN, MoSi₂.

3. The process as claimed in claim 2, wherein the MCrAlY powder and the ceramic material are fed to the injection nozzle individually.

4. (Canceled)

5. The process as claimed in claim 2, wherein the toothed or pointed shape is cut to a height of 0.1 to 1 mm.

6. The process as claimed in claim 2, wherein the base material which is coated is a turbine blade or vane, and the location which is subject to friction is the tip of the turbine blade or vane, or another part of a gas turbine or a compressor which is subject to friction is coated.

7. The process as claimed in claim 2, wherein the thermal spraying process used is a plasma spraying process, high-velocity spraying, flame spraying, a detonation process, wire spraying or high-pressure air spraying.

8. A base material which is subject to friction and is coated with a MCrAlY stripping coating using the process as claimed in claim 1, wherein the coating contains ceramic particles and is cut into a toothed or pointed shape at locations which are subject to friction.

9. The base material which is subject to friction as claimed in claim 8, wherein the coating contains hard-phase fractions.

10. The base material as claimed in claim 8, wherein the ceramic powder is one or a combination of the following materials: Al₂O₃, Si₃N₄, SiC, AlN, Cr₃C₂ and MoSi₂.

11. The base material as claimed in claim 8, wherein the base material is a turbine blade or vane, and the location which is subject to friction is the tip of the turbine blade or vane, or is another part of a gas turbine or a compressor which is subject to friction.

12. The base material as claimed in claim 8, wherein the coating is segmented.

13. The base material as claimed in claim 8, wherein the toothed or pointed shape has a height of 0.1 to 1 mm.

14. The process as claimed in claim 2, wherein the MCrAlY powder and the ceramic material are fed to the injection nozzle together.
